(19) United States
(12) Patent Application Publication
(10) Pub. No.: US 2006/0069832 A1
(43) Pub. Date: Mar. 30, 2006

(54) Information processing apparatus and method and program

(75) Inventor: Ryoichi Imaizumi, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/227,196

(22) Filed: Sep. 16, 2005

(30) Foreign Application Priority Data
Sep. 28, 2004 (JP) 2004-280817

(51) Int. Cl. G06F 13/00

(52) U.S. Cl. 710/110

(57) ABSTRACT

An information processing apparatus including a plurality of slave processors connected to a system bus and a main processor controlling the plurality of slave processors includes holding means for holding profile information of processing modules executable by the slave processors, selection means for selecting processing modules to be executed by the slave processors in accordance with the profile information, execution means for causing the slave processors to execute the processing modules selected by the selection means, generation means for generating a compound module for performing a plurality of pieces of processing by combining predetermined simple modules in response to a request, and storage means for storing the compound module generated by the generation means. The profile information includes dependency information of input data, and the generation means generates the compound module in accordance with the dependency information.

### CROSS REFERENCES TO RELATED APPLICATIONS

The present invention contains subject matter related to Japanese Patent Application JP 2004-280817 filed in the Japanese Patent Office on Sep. 28, 2004, the entire contents of which are incorporated herein by reference.

### BACKGROUND OF THE INVENTION

1. Field of the Invention

The present invention relates to information processing apparatuses, information processing methods, and programs, and more particularly, to an information processing apparatus, an information processing method, and a program for distributing predetermined processing over a plurality of slave processors and for causing the plurality of slave processors to execute the distributed processing.

2. Description of the Related Art

Arithmetic devices for distributing processing over a plurality of arithmetic units (hereinafter, referred to as slave processors) connected to system buses and for causing the plurality of slave processors to execute the distributed processing at high speed have been suggested. (See, for example, Japanese Unexamined Patent Application Publication Nos. 9-18593 and 2002-351850.)

For such systems, as methods for sequentially executing image post-processing including a plurality of pieces of simple processing, such as noise reduction, edge enhancement, and RGB image conversion, a method for assigning each piece of simple processing to a corresponding slave processor and for causing the corresponding slave processor to execute the assigned simple processing (hereinafter, appropriately referred to as “simple-module processing”) and a method for generating an execution object to execute some pieces of simple processing together and for causing a slave processor to execute the execution object (hereinafter, appropriately referred to as “compound-module processing”) are available.

For simple-module processing, since a large amount of resource, such as a large memory size in a slave processor, is used for a piece of processing (image post-processing), the processing can be executed at high speed. However, obviously, simple-module processing uses a large amount of resource.

For compound-module processing, a small amount of resource is used. However, compound-module processing is executed at a lower speed compared with simple-module processing. In particular, for a multicore processor in which slave processors are mounted in one chip, the speed of compound-module processing is significantly reduced. Since a slave processor has a small memory size, storage into a main memory is required. Thus, such processing needs a certain amount of time.

Normally, it is difficult to estimate in advance a resource usable at a point in time, such as the number of slave processors and a usable bandwidth. Thus, one of the above-mentioned methods determined in advance has been used.

### SUMMARY OF THE INVENTION

However, in a case where a usable resource dynamically changes, the following problems occur. When compound-module processing is adopted, some slave processors do not operate. In addition, when simple-module processing is adopted, for example, the bandwidth of a system bus is pressured due to other processing being executed during the execution the simple-module processing or a resource is limited due to frequent context switching of a slave processor. Accordingly, the entire performance is reduced.

It is desirable to distribute processing over a plurality of slave processors connected to a system bus and to cause the plurality of slave processors to efficiently execute the distributed processing.

An information processing apparatus according to an embodiment of the present invention including a plurality of slave processors connected to a system bus and a main processor controlling the plurality of slave processors includes holding means for holding profile information of processing modules executable by the slave processors, selection means for selecting processing modules to be executed by the slave processors in accordance with the profile information, execution means for causing the slave processors to execute the processing modules selected by the selection means, generation means for generating a compound module for performing a plurality of pieces of processing by combining predetermined simple modules in response to a request, and storage means for storing the compound module generated by the generation means. The profile information includes dependency information of input data, and the generation means generates the compound module in accordance with the dependency information.

The profile information may include a processing speed, the amount of memory used, or a system bus usage for each of the processing modules.

The information processing apparatus may further include acquisition means for acquiring profile results corresponding to execution of the processing modules and update means for updating the profile information in accordance with the profile results.

The information processing apparatus may further include monitoring means for monitoring a use state of a resource during execution of the processing modules. The selection means may reselect processing modules to be executed by the slave processors in accordance with the use state of the resource.

The resource may include a bandwidth of the system bus, the number of slave processors executing the processing modules, or a usage rate of the slave processors.

The information processing apparatus may further include previous data holding means for holding previous resource information. The selection means may reselect the processing modules to be executed by the slave processors in accordance with the previous resource information.

An information processing method according to an embodiment of the present invention for an information processing apparatus including a plurality of slave processors connected to a system bus and a main processor controlling the plurality of slave processors includes the steps of holding profile information of processing modules executable by the slave processors, selecting processing modules to be executed by the slave processors in accordance with the profile information, causing the slave processors to execute the processing modules selected by the selecting step, generating a compound module for performing a plurality of pieces of processing by combining predetermined simple modules in response to a request, and storing the compound module generated by the generating step. The profile information includes dependency information of input data, and the compound module is generated by the generating step in accordance with the dependency information.

A program according to an embodiment of the present invention includes the steps of holding profile information of processing modules executable by the slave processors, selecting processing modules to be executed by the slave processors in accordance with the profile information, causing the slave processors to execute the processing modules selected by the selecting step, generating a compound module for performing a plurality of pieces of processing by combining predetermined simple modules in response to a request, and storing the compound module generated by the generating step. The profile information includes dependency information of input data, and the compound module is generated by the generating step in accordance with the dependency information.

Accordingly, in the foregoing information processing apparatus, information processing apparatus, and program, profile information of processing modules that can be executed by slave processors is held, processing modules to be executed by the slave processors are selected in accordance with the profile information, and the slave processors execute the selected processing modules.

Accordingly, predetermined processing can be distributed over a plurality of slave processors connected to a system bus and the distributed processing can be effectively executed by the plurality of slave processors.

### BRIEF DESCRIPTION OF THE DRAWINGS

FIG. 1 is a block diagram showing an example of the structure of an image processing apparatus according to an embodiment of the present invention;

FIG. 2 is a block diagram showing an example of the structure of each of slave processors shown in FIG. 1;

FIG. 3 is an illustration for explaining an operation of the slave processors;

FIG. 4 shows a data flow;

FIG. 5 is an illustration for explaining processing of the slave processors for each frame;

FIG. 6 is an illustration for explaining another operation of the slave processors;

FIG. 7 is a block diagram showing an example of a functional structure of the image processing apparatus shown in FIG. 1;

FIG. 8 shows profile information stored in a module storage unit shown in FIG. 7;

FIG. 9 is a flowchart of a process performed by a module selector shown in FIG. 7;

FIGS. 10A to 10D are illustrations for explaining examples of an operation of the module selector shown in FIG. 7;

FIG. 11 shows a profile of each of predetermined processing modules;

FIGS. 12A to 12C are illustrations for explaining examples of an operation of the module selector;

FIG. 13 is a block diagram showing another example of the functional structure of the image processing apparatus shown in FIG. 1;

FIG. 14 is a flowchart of a process performed by a resource monitor shown in FIG. 13;

FIG. 15 is a flowchart of a process performed by the module selector shown in FIG. 13;

FIG. 16 is a block diagram showing another example of the functional structure of the image processing apparatus shown in FIG. 1;

FIG. 17 is a flowchart of a process performed by a module selector shown in FIG. 16;

FIG. 18 is a block diagram showing another example of the functional structure of the image processing apparatus shown in FIG. 1;

FIG. 19 is a flowchart of a process performed by a module manager shown in FIG. 18;

FIG. 20 shows profile information stored in a simple module source storage unit shown in FIG. 18;

FIG. 21 shows a profile of each of predetermined processing modules;

FIG. 22 is a block diagram showing another example of the functional structure of the image processing apparatus shown in FIG. 1; and

FIG. 23 is a flowchart of a profile update process.

### DESCRIPTION OF THE PREFERRED EMBODIMENTS

Before describing embodiments of the present invention, the correspondence between the invention described in this specification and the embodiments of the present invention will be discussed below. This description is provided to confirm that the embodiments supporting the invention described in this specification are described in this specification. Thus, even if an embodiment described in the embodiments of the present invention is not described here as relating to an aspect of the present invention, this does not mean that the embodiment does not relate to that aspect of the present invention. In contrast, even if an embodiment is described here as relating to an aspect of the present invention, this does not mean that the embodiment does not relate to other aspects of the present invention.

Furthermore, this description should not be construed as restricting that all the aspects of the present invention described in this specification are described. In other words, this description does not preclude the existence of aspects of the present invention that are described in this specification but that are not claimed in this application, in other words, does not preclude the existence of aspects of the present invention claimed by a divisional application or added by amendment in the future.

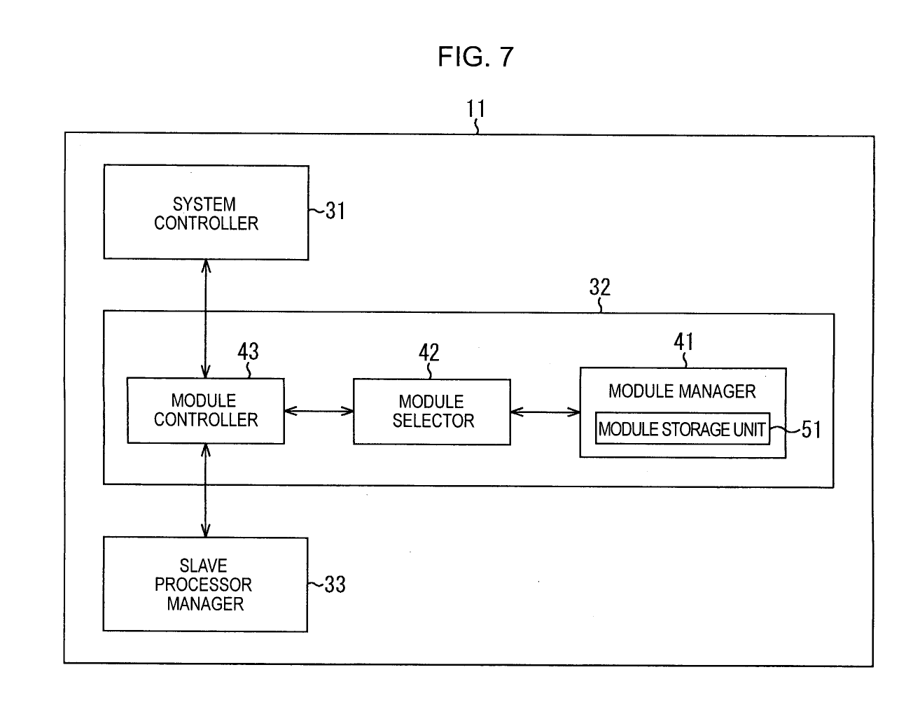

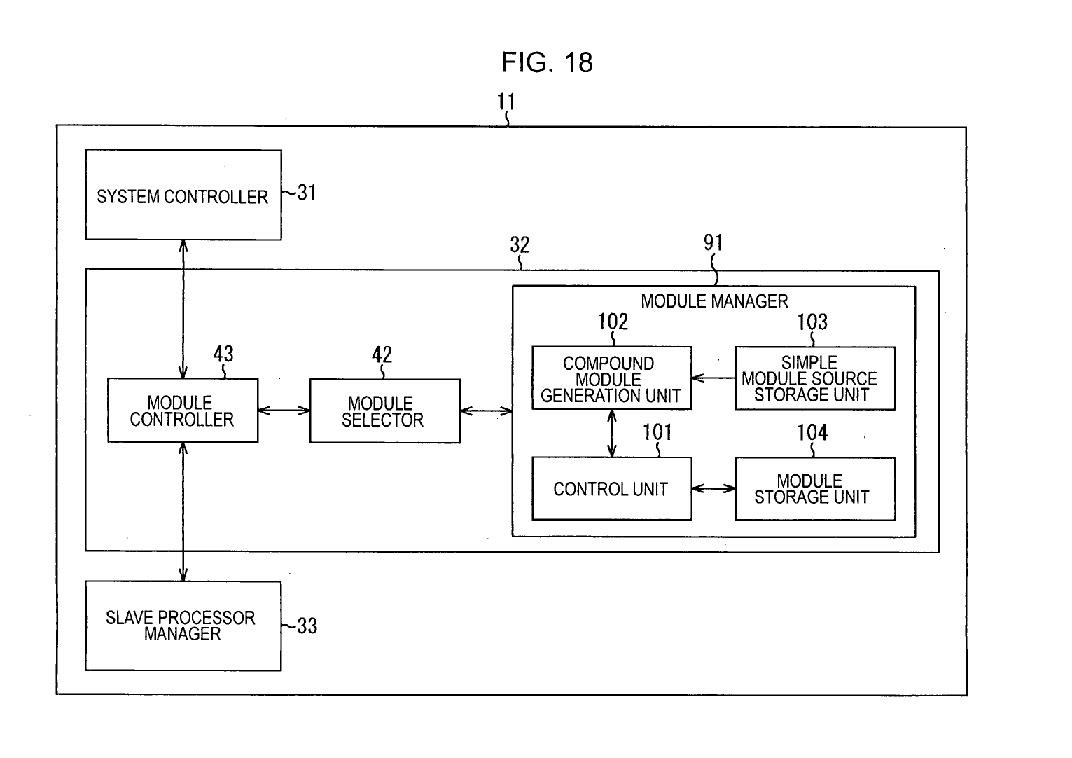

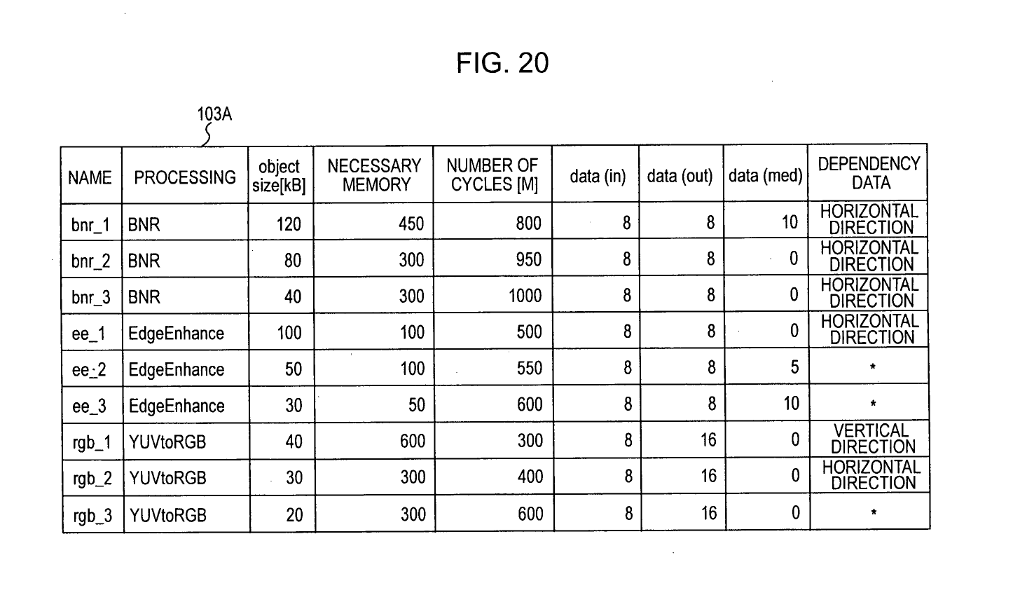

An information processing apparatus according to an embodiment of the present invention includes holding means (for example, a module storage unit 51 in FIG. 7) for holding profile information of processing modules executable by the slave processors, selection means (for example, a module selector 42 in FIG. 7) for selecting processing modules to be executed by the slave processors in accordance with the profile information, execution means (for example, a module controller 43 in FIG. 7) for causing the slave processors to execute the processing modules selected by the selection means, generation means (for example, a compound module generation unit 102 in FIG. 18) for generating a compound module for performing a plurality of pieces of processing by combining predetermined simple modules in response to a request, and storage means (for example, a module storage unit 104 in FIG. 18) for storing the compound module generated by the generation means. The profile information includes dependency information (for example, dependency data in FIG. 20) of input data, and the generation means generates the compound module in accordance with the dependency information.

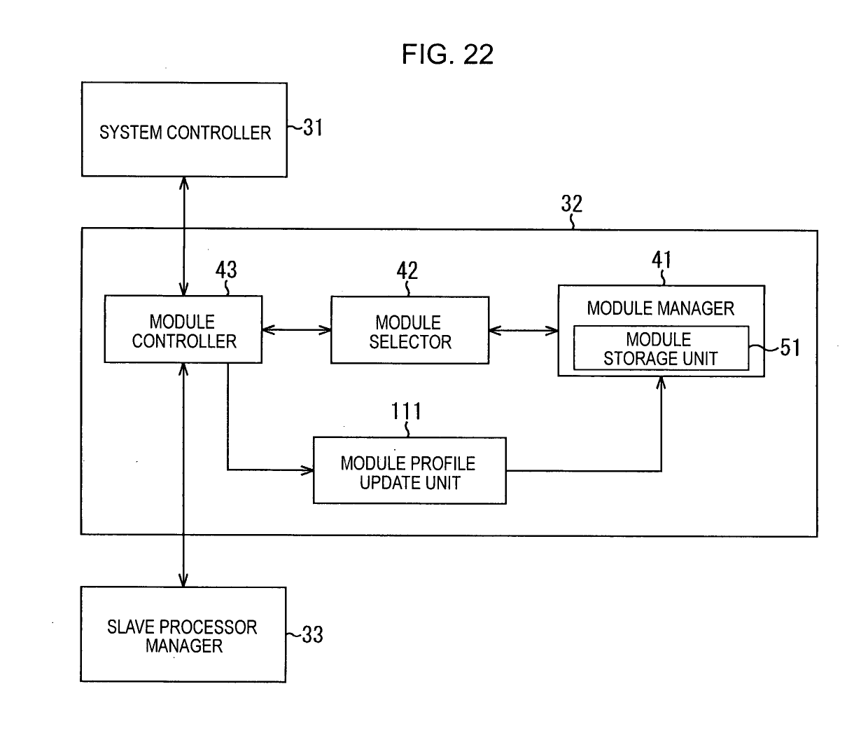

The information processing apparatus may further include acquisition means (for example, a module profile update unit 111 in FIG. 22) for acquiring profile results corresponding to execution of the processing modules and update means (for example, a module manager 41 in FIG. 22) for updating the profile information in accordance with the profile results.

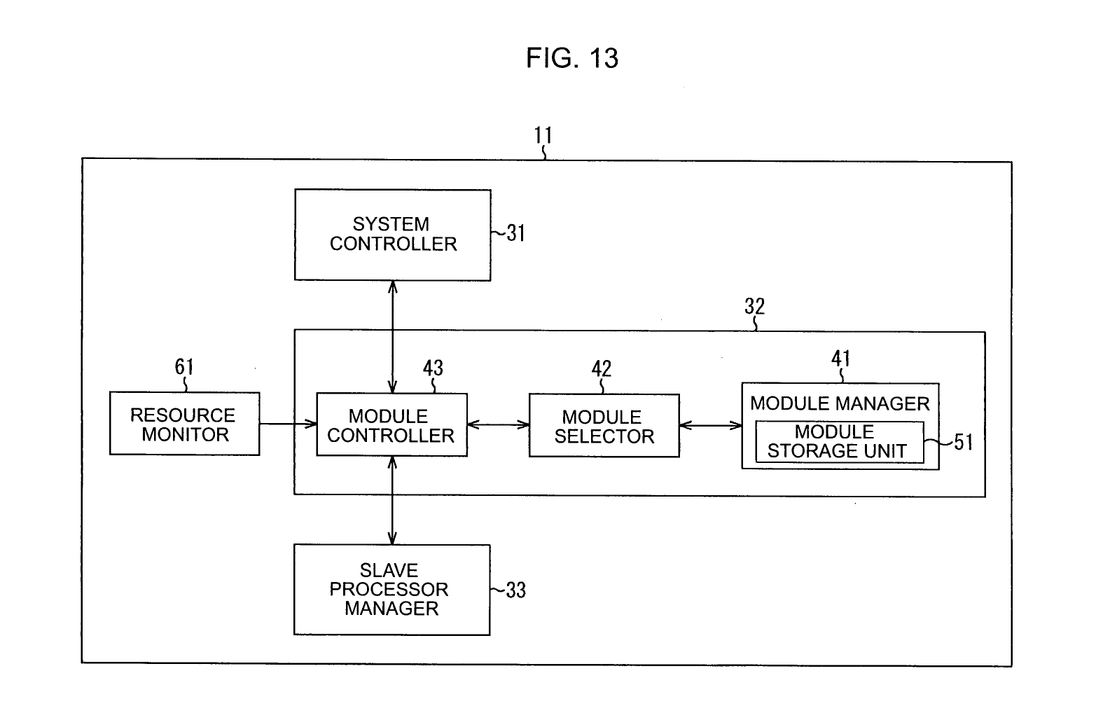

The information processing apparatus may further include monitoring means (for example, a resource monitor 61 in FIG. 13) for monitoring a use state of a resource during execution of the processing modules. The selection means may reselect processing modules to be executed by the slave processors in accordance with the use state of the resource.

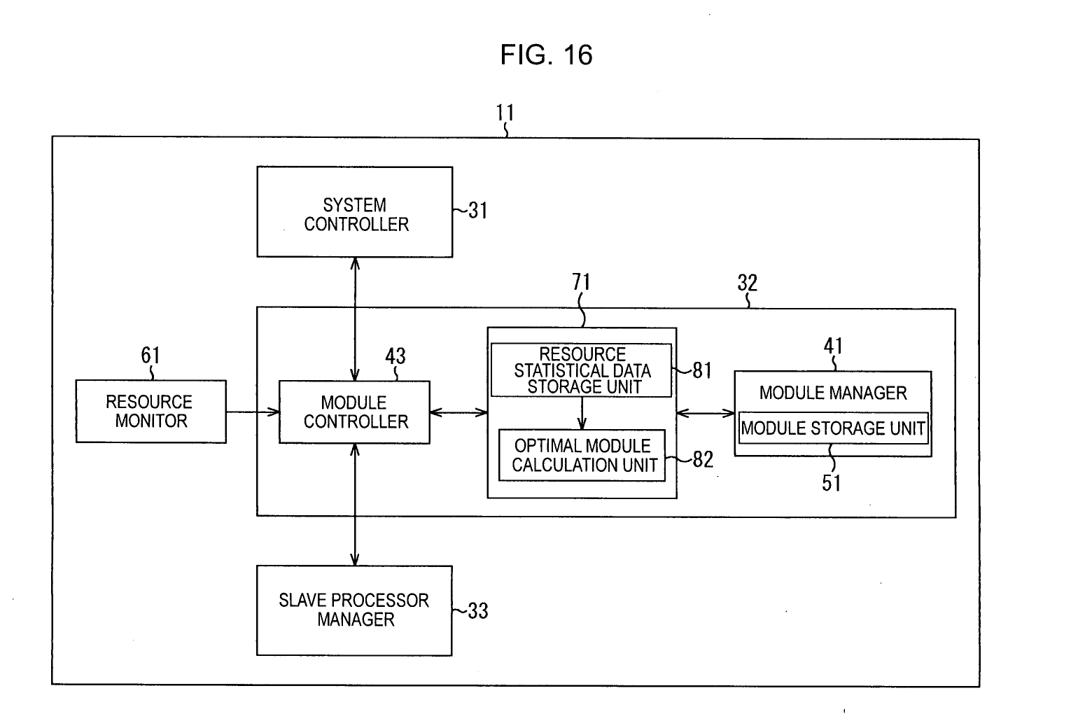

The information processing apparatus may further include previous data holding means (for example, a resource statistical data storage unit 81 in FIG. 16) for holding previous resource information. The selection means (for example, an optimal module calculation unit 82) may reselect the processing modules to be executed by the slave processors in accordance with the previous resource information.

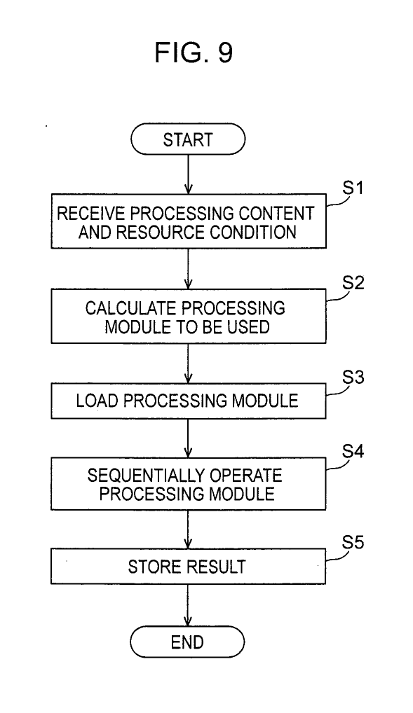

An information processing method according to an embodiment of the present invention includes the steps of holding profile information of processing modules executable by the slave processors (for example, processing of the module storage unit 51 in FIG. 7), selecting processing modules to be executed by the slave processors in accordance with the profile information (for example, step S2 in FIG. 9), causing the slave processors to execute the processing modules selected by the selecting step (for example, steps S3 and S4 in FIG. 9), generating a compound module for performing a plurality of pieces of processing by combining predetermined simple modules in response to a request, and storing the compound module generated by the generating step. The profile information includes dependency information of input data, and the compound module is generated by the generating step in accordance with the dependency information.

A program according to an embodiment of the present invention includes the steps of holding profile information of processing modules executable by the slave processors (for example, processing of the module storage unit 51 in FIG. 7), selecting processing modules to be executed by the slave processors in accordance with the profile information (for example, step S2 in FIG. 9), causing the slave processors to execute the processing modules selected by the selecting step (for example, steps S3 and S4 in FIG. 9), generating a compound module for performing a plurality of pieces of processing by combining predetermined simple modules in response to a request, and storing the compound module generated by the generating step. The profile information includes dependency information of input data, and the compound module is generated by the generating step in accordance with the dependency information.

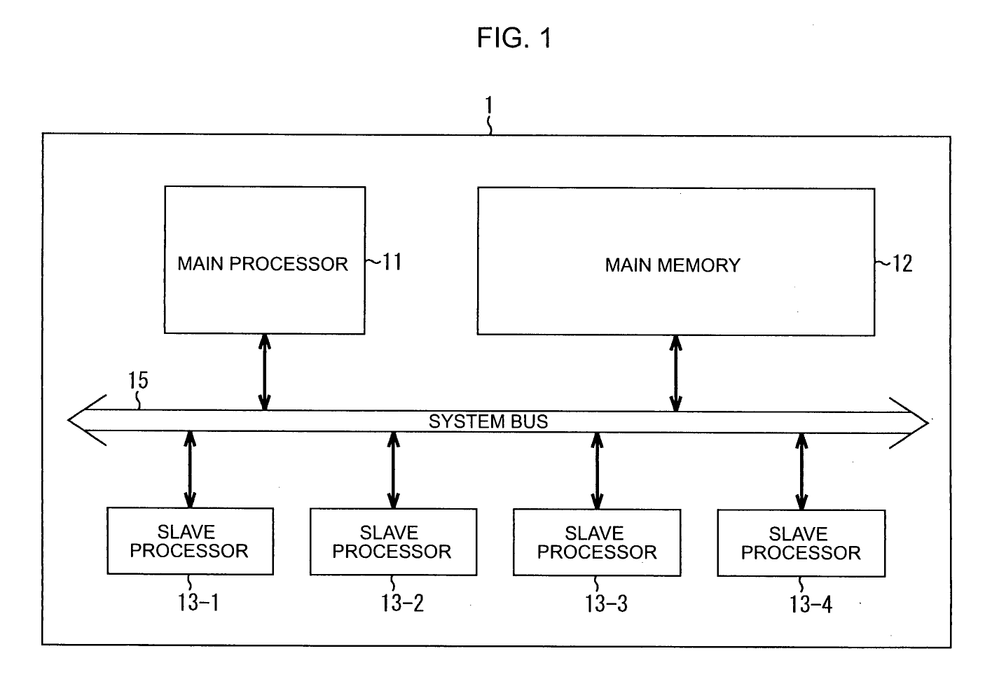

FIG. 1 shows the structure of an image processing apparatus 1 according to an embodiment of the present invention.

The image processing apparatus 1 includes a main processor 11, a main memory 12, and slave processors 13-1, 13-2, 13-3, and 13-4 (hereinafter, if there is no need to distinguish among the slave processors 13-1 to 13-4, they are simply referred to as slave processors 13). The main processor 11, the main memory 12, and the slave processors 13 are connected to each other with a system bus 15 therebetween. In FIG. 1, only portions necessary for arithmetic processing are shown, and external interfaces, such as a hard disk, a network interface, a keyboard, and a monitor, are not illustrated.

The main processor 11 is a standard microprocessing unit (MPU) and controls the entire apparatus. More specifically, in accordance with “processing contents” to be executed correspondingly to required processing and “resource conditions”, the main processor 11 provides the slave processors 13 with processing modules managed by the main processor 11, and causes the slave processors 13 to execute the corresponding processing.

For example, when “processing contents” to be executed correspondingly to required image post-processing are noise reduction (block noise reduction (BNR)), image quality improvement (edge enhancement filtering), and format conversion (RGB conversion), and when “resource conditions” are “three slave processors” and “a bandwidth of 100 Mbps or less”, the main processor 11 determines processing modules (or a combination of some processing modules) to execute “BNR”, “edge enhancement filtering”, and “RGB conversion” by three slave processors 13 with a bandwidth of 100 Mbps or less. Then, the main processor 11 provides the slave processors 13 with the determined corresponding processing modules and causes the slave processors 13 to execute the corresponding processing modules.

For example, “a processing content” may be “contrast adjustment” or “mosquito noise reduction”, in addition to “BNR”, “edge enhancement filtering”, and “RGB conversion”. For example, “a resource condition” may be “a memory usage”, “the usage rate of a slave processor”, “a processing speed of a processing module”, or “a system bus usage”, in addition to “the number of slave processors” and “a bandwidth”.

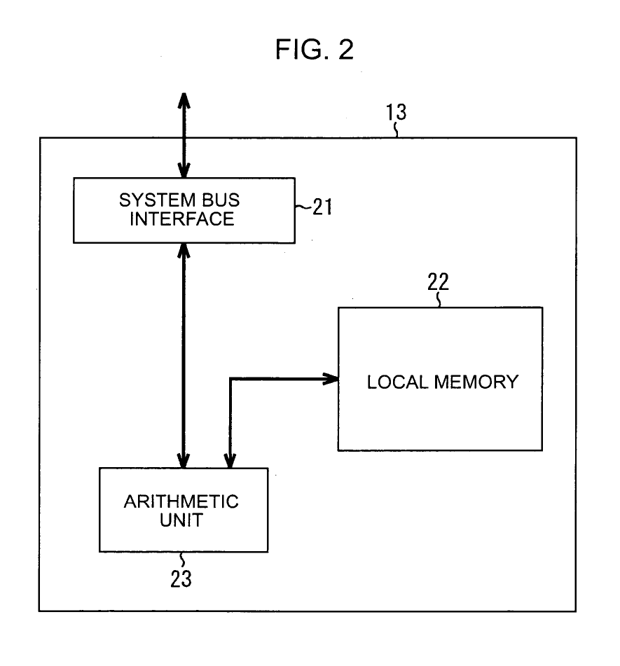

Each slave processor 13 has a structure shown in FIG. 2. In other words, the slave processor 13 receives an instruction from the main processor 11 and an execution code loaded from the main memory 12 by communicating with the main processor 11 and the main memory 12 via a system bus interface 21. A local memory 22 stores the execution code loaded from the main memory 12 and other data. An arithmetic unit 23 performs an arithmetic operation of the execution code stored in the local memory 22 in accordance with the instruction from the main processor 11, and executes predetermined processing.

Operations of the slave processors 13 when processing modules of noise reduction (block noise reduction (BNR)), image quality improvement (edge enhancement filtering), and format conversion (RGB conversion) are executed as image post-processing will now be described.

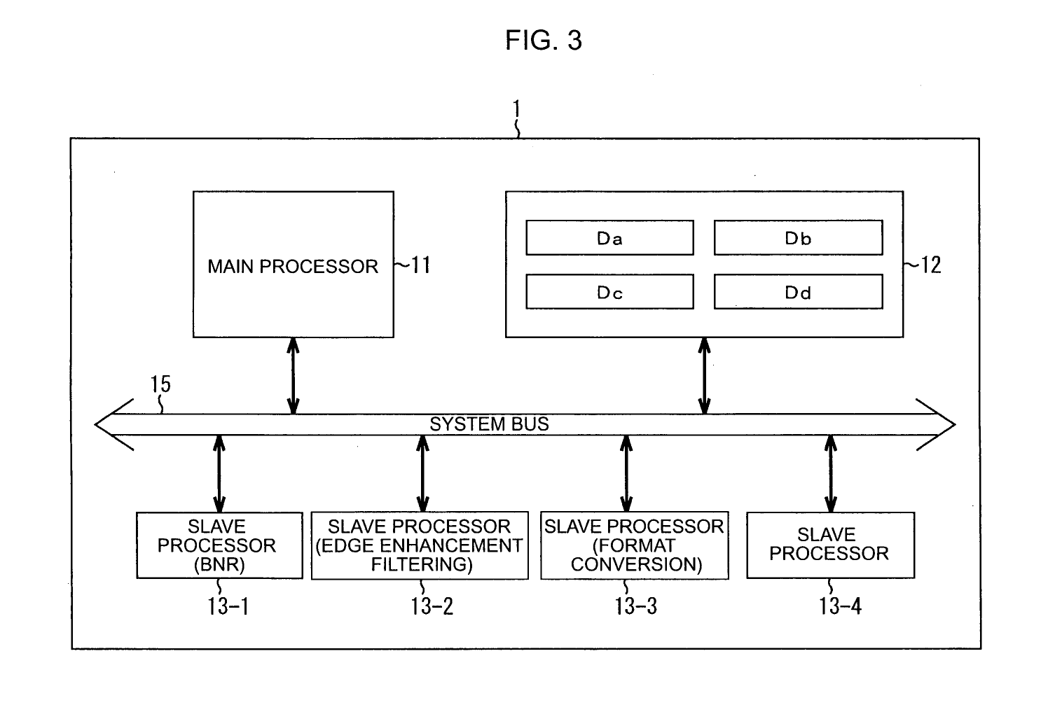

In actual assignment of processing, processing modules to execute processing are loaded to the corresponding slave processors 13, as described below. In this example, however, as shown in FIG. 3, a processing module for “BNR” is loaded to the slave processor 13-1, a processing module for “edge enhancement filtering” is loaded to the slave processor 13-2, and a processing module for “format conversion” is loaded to the slave processor 13-3. In other words, image post-processing is sequentially performed based on simple-module processing.

The BNR processing module loaded to the slave processor 13-1 reads data from image data Da that is stored in the main memory 12 and that stores an original YUV image, reduces noise, and outputs a result to image data Db.

The edge enhancement filtering processing module loaded to the slave processor 13-2 reads data from the image data Db stored in the main memory 12, performs edge enhancement on the read data, and outputs a result to image data Dc.

The format conversion processing module loaded to the slave processor 13-3 reads data from the image data Dc, and outputs an RGB-converted result to image data Dd.

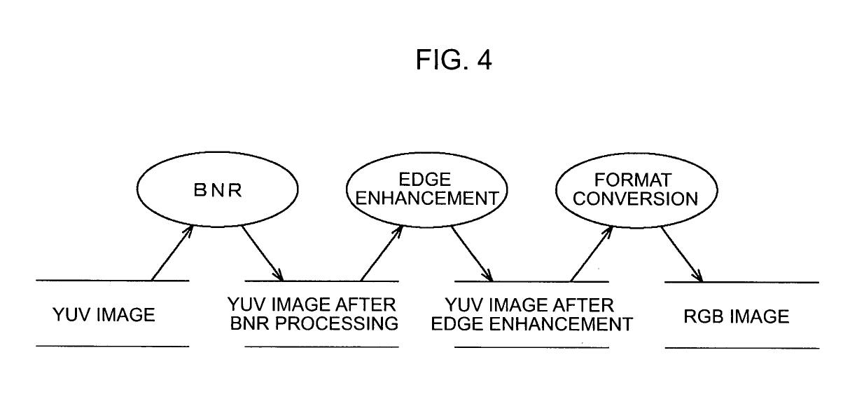

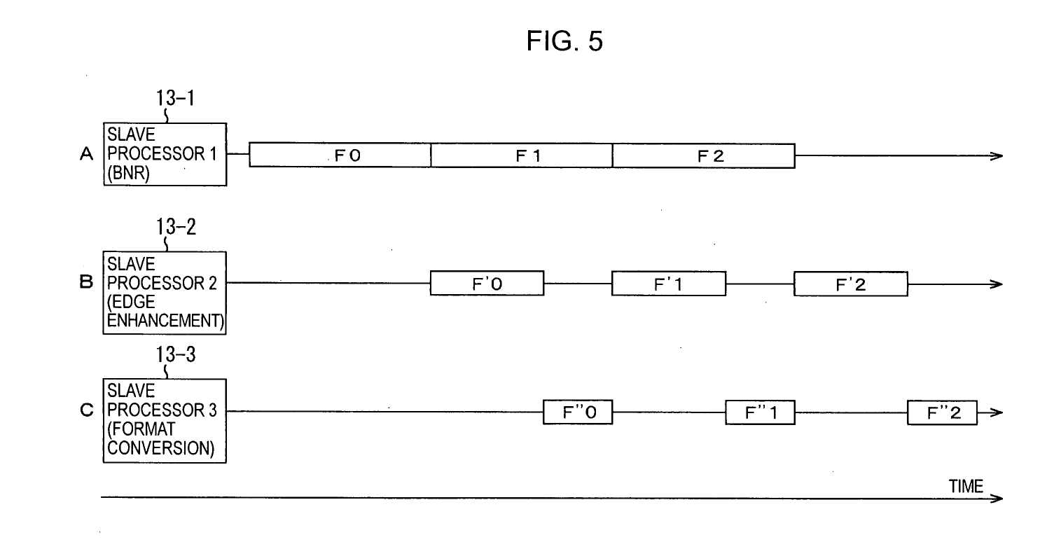

In other words, the data flow in this case is shown as in FIG. 4. The processing flow for each frame can be shown as in FIG. 5. For example, first, the slave processor 13-1 executes BNR processing on an image of a frame F0, and then the slave processor 13-2 executes edge enhancement processing on an image of a frame F′0. Finally, the slave processor 13-3 executes format conversion on an image of a frame F″0.

If it is difficult to read all the image data by a single operation due to the size of the local memory 22 of the slave processor 13, processing for partially reading image data to the local memory 22 and for outputting a processing result to the main memory 12 is repeatedly performed.

The operations of the slave processors 13 have been described with reference to FIG. 3 as an example of a case where image post-processing is performed based on simple-module processing. Operations of the slave processors 13 when image post-processing is performed based on compound-module processing will now be described.

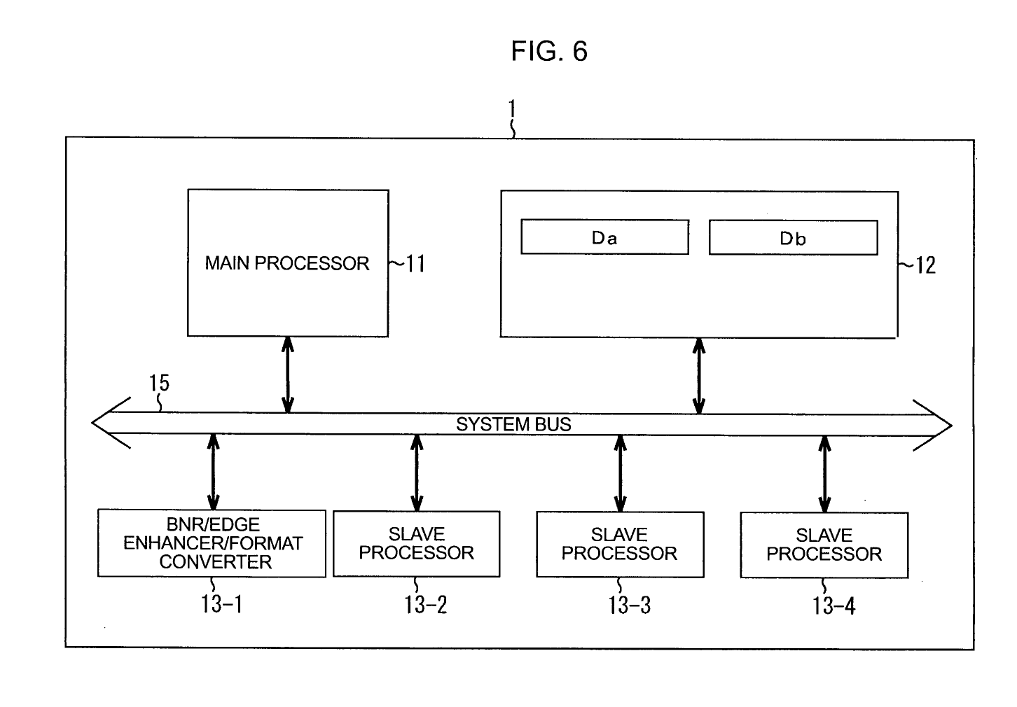

In this example, a compound module performs “BNR”, “edge enhancement filtering”, and “RGB conversion” in that order. In an example shown in FIG. 6, the compound module is loaded to the slave processor 13-1. In other words, the processing module loaded to the slave processor 13-1 reads an original YUV image stored in image data Da in the main memory 12, sequentially performs BNR, edge enhancement filtering, and format conversion, and outputs a processing result to image data Db.

In a method using a compound module, processing for an image may be performed at a lower speed compared with a case where simple modules are loaded to the plurality of slave processors 13. Simple-module processing can be performed at a higher speed for the following reasons:

Many intermediate processing results can be stored. For data processing, intermediate results are temporarily stored. If there is not a sufficient memory size, an intermediate result may be disposed of and may be recalculated. In addition, a storage format of an intermediate result may be converted into a format that does not consume a large amount of memory. For example, a processing result output using an integer vector is converted into a char vector to be stored, and then, the char vector is reconverted into an integer vector to be used. If there is a sufficient memory size, there is no need to perform such conversion. Thus, processing can be performed at a higher speed.

A large object code can be achieved. In other words, speedup techniques, such as function inline expansion and loop unrolling, increase the size of an execution code. If the size of a local memory that can be used by a module is large, much more inline expansion and loop unrolling can be performed.

If a usable memory size is large, totally different algorithms can be used. In this case, the processing speed can be significantly increased.

FIG. 7 shows an example of the functional structure of a software module operating on the main processor 11, that is, the functional structure of the image processing apparatus 1.

A system controller 31 supplies “processing contents” to be executed correspondingly to required processing and usable resources (resource conditions) to an image processor 32, and requires the image processor 32 to perform the processing.

For example, “processing contents”, such as “BNR”, “edge enhancement filtering”, and “RGB conversion”, and “resource conditions”, such as “two slave processors” and “a bandwidth of 10 Mbps or less”, are reported to the image processor 32. Alternatively, for example, “processing contents”, such as “BNR”, “edge enhancement filtering”, “contrast adjustment”, “mosquito noise reduction”, and “RGB conversion”, and “resource conditions”, such as “four slave processors” and “a bandwidth of 100 Mbps or less”, are reported to the image processor 32.

The image processor 32 manages processing modules which perform image processing. The image processor 32 provides a slave processor manager 33 with processing modules corresponding to the “processing contents” and the “resource conditions” supplied from the system controller 31.

The slave processor manager 33 loads execution codes of the supplied processing modules to the slave processors 13 in accordance with instructions from the image processor 32 and activates the processing modules.

The details of the image processor 32 are given next. The image processor 32 includes a module manager 41, a module selector 42, and a module controller 43.

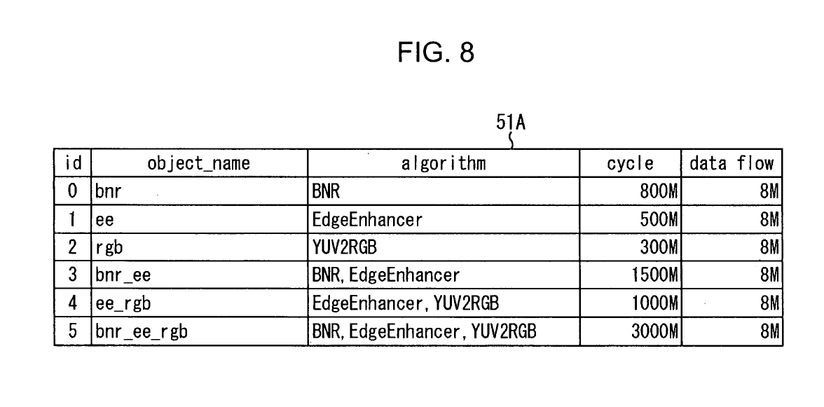

Profile information SA shown in FIG. 8 on processing modules operating on the slave processors 13 is stored in a module storage unit 51. The module manager 41 manages the processing modules in accordance with the profile information 51A.

In the profile information 51A shown in FIG. 8, “id” represents an identification (ID) of a processing module, and “object_name” represents the name of a processing module. If the entity of a processing module exists in a particular path, the path can be traced back using the object_name.

In addition, in a column for “algorithm”, image processing algorithms to be executed by a processing module are described in order in a comma separated value (CSV) format.

In addition, “cycle” represents the number of cycles necessary for executing a processing module for a predetermined reference image. In addition, “data flow” represents the amount of data flowing between the main memory 12 and the local memory 22 when a processing module executes processing on the reference image.

The module selector 42 selects processing modules that correspond to “processing contents” reported from the system controller 31 and that correspond to “resource conditions” from among processing modules managed by the module manager 41 in accordance with the profile information 51A. The module selector 42 acquires the selected processing modules from the module manager 41, and supplies the acquired processing modules to the module controller 43.

The module controller 43 receives requests including “processing contents” and “resource conditions” from the system controller 31, and supplies the requests to the module selector 42. The module controller 43 also supplies to the slave processor manager 33 the processing modules supplied from the module selector 42 in response to the requests from the system controller 31, and causes predetermined slave processors 13 to perform the processing modules.

A process performed by the image processor 32 is described next with reference to a flowchart shown in FIG. 9.

In step S1, the module controller 43 of the image processor 32 receives a report about “processing contents” and “resource conditions” from the system controller 31, and supplies the “processing contents” and the “resource conditions” to the module selector 42.

In step S2, the module selector 42 calculates processing modules to be used, and acquires the processing modules from the module manager 41. The module selector 42 supplies the acquired processing modules to the module controller 43.

A calculation method of a processing module is described next. “The number of cycles (cycle)” necessary for processing and “the amount of a data flow (data flow)” are stored in the profile information 51A. “Speed” necessary for the processing can be known from “the number of cycles” and “a bandwidth” necessary for the processing can be known from “the amount of the data flow” and “the number of cycles”. Thus, the module selector 42 acquires the profile information 51A from the module manager 41 and selects processing modules that perform “processing contents” and that satisfy “resource conditions” in accordance with “the number of cycles” and “the amount of the data flow” stored in the profile information 51A.

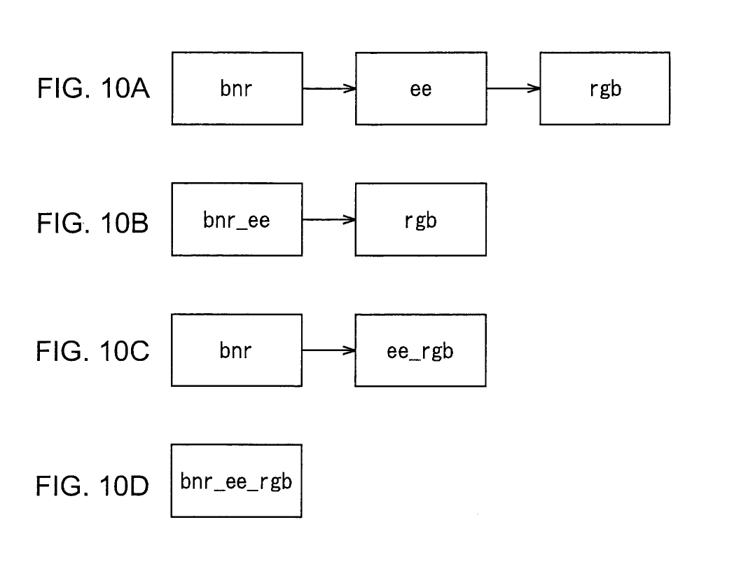

For example, when the “processing contents” are “BNR”, “edge enhancement filtering”, and “RGB conversion”, four combination patterns of processing modules are possible. In other words, a pattern (see FIG. 10A) in which a processing module bnr for performing “BNR”, a processing module ee for performing “edge enhancement filtering”, and a processing module rgb for performing “RGB conversion” are used, a pattern (see FIG. 10B) in which a processing module bnr_ee for sequentially performing “BNR” and “edge enhancement filtering” and a processing module rgb for performing “RGB conversion” are used, a pattern (see FIG. 10C) in which a processing module bnr for performing “BNR” and a processing module ee_rgb for sequentially performing “edge enhancement filtering” and “RGB conversion” are used, and a pattern (see FIG. 10D) in which only a processing module bnr_ee_rgb for sequentially performing “BNR”, “edge enhancement filtering”, and “format conversion” is used are possible.

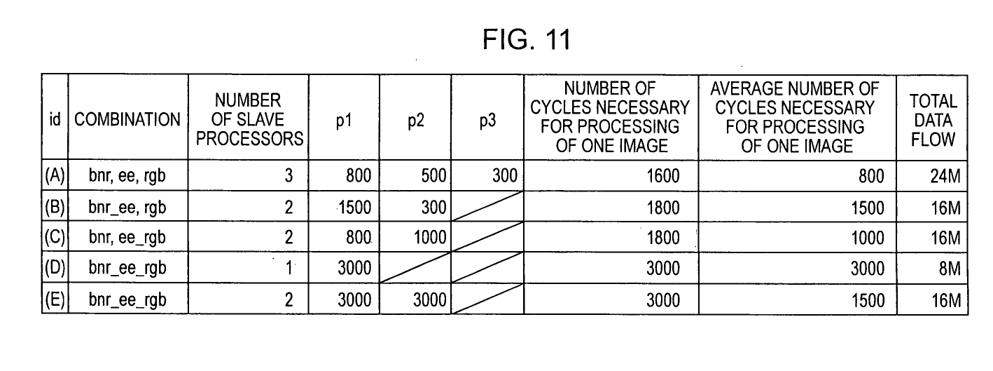

In this case, as shown in FIG. 11, the module selector 42 reads from the profile information 51A, for example, the number of cycles necessary for each case. In FIG. 11, “the number of slave processors” represents the number of slave processors necessary for performing each combination of processing operations in parallel, and “p1”, “p2”, and “p3” represent the numbers of cycles necessary for the respective slave processors 13. In addition, “the number of cycles necessary for processing of one image” represents latency, and “the average number of cycles for processing of one image” represents a throughput.

For example, the processing module bnr_ee_rgb may be loaded to a plurality of slave processors 13 (a pattern whose ID is (E)) in order to perform processing on different frame images if the processing does not have dependency relationship between the frames. In addition, a method for sequentially loading the processing module bnr, the processing module ee, and the processing module rgb to a slave processor 13 and for causing the slave processor 13 to execute the processing is precluded since a large overhead is used for object loading.

When “a resource condition” is “two slave processors”, patterns whose IDs are (B), (C), and (E) are possible. Since the best performance can be achieved by the pattern whose ID is (C), processing modules forming this pattern are selected.

When a “resource condition” is “a data flow of 10 megabytes or less”, a pattern whose ID is (D) satisfies the condition. Thus, a processing module forming this pattern is selected.

As described above, the module selector 42 acquires selected processing modules from the module manager 41, and supplies the acquired processing modules to the module controller 43.

Referring back to FIG. 9, in step S3, the module controller 43 loads the processing modules supplied from the module selector 42 to the corresponding slave processors 13 via the slave processor manager 33.

In step S4, the module controller 43 activates the loaded modules in an appropriate order and at an appropriate time, and causes the slave processors 13 to perform corresponding processing.

In step S5, the system controller 31 stores execution results (for example, images) of the processing modules of the slave processors 13 output to the main memory 12 in proper positions in the main memory 12.

As described above, a combination of processing modules corresponding to “processing contents” and “resource conditions” is selected, and image post-processing is performed by the corresponding processing modules in a distributed manner.

Since each processing has the same “amount of data flow”, as shown in FIG. 11, when processing modules are connected to each other, the total amount of the data flow simply reduces in accordance with the number of connected processing modules, that is, the number of slave processors 13. Generally, however, the total amount of the data flow may change depending on the combination of processing modules even if the same number of slave processors 13 is used. This is for the following two specific reasons:

For a case where output data of a module increases

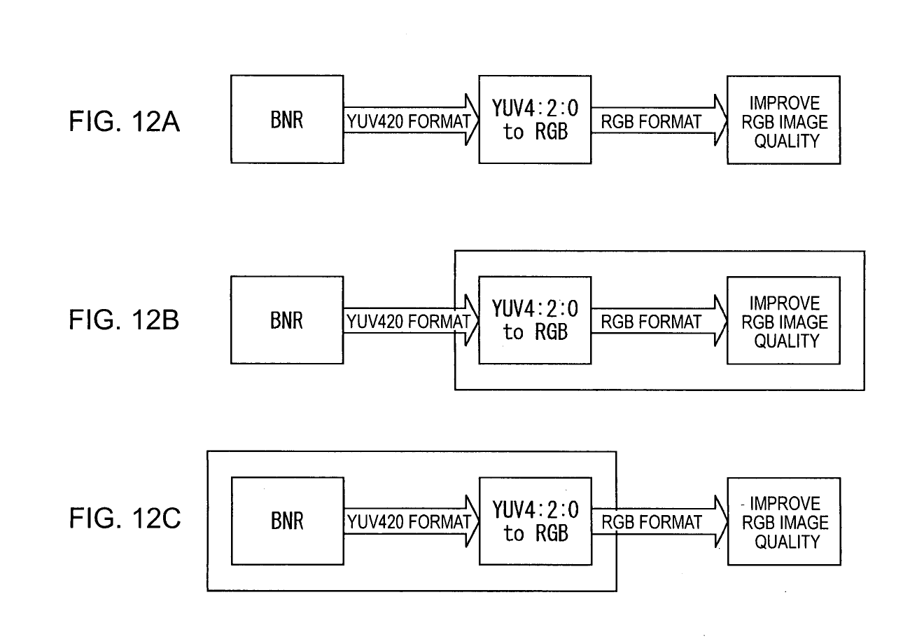

For example, when image quality improvement is performed on only an RGB input image, the amount of data flow of a compound module formed as shown in FIG. 12B is smaller than the amount of data flow of a compound module formed as shown in FIG. 12C.

For a case where in-process data is stored in the main memory 12

When the local memory 22 of a slave processor 13 does not have an enough size, in-process data is saved in the main memory 12. When such a processing module is connected to another processing module, by connecting to a processing module whose object size is smaller, a buffer for storing the in-process data in the local memory 22 can be increased. Thus, the amount of data flowing between the local memory 22 and the main memory 12 reduces.

Thus, when “the amount of a data flow” is provided as “a resource condition”, a combination having a smaller “amount of data flow” should be selected from among combinations having the same number of slave processors 13.

FIG. 13 shows another example of the functional structure of the image processing apparatus 1 (another example of the structure of the software module operating on the main processor 11). With this structure, the image processing apparatus 1 further includes a resource monitor 61 connected to the image processor 32 shown in FIG. 7.

The resource monitor 61 monitors the current resource usage, and reports the current resource usage to the module controller 43 of the image processor 32. Due to the existence of the resource monitor 61, the system controller 31 does not need to sequentially report a resource use state which dynamically changes, such as a bandwidth used for the system bus 15, and an optimal module arrangement can be automatically set.

In this case, the system controller 31 only needs to provide upper limits, such as the maximum number of usable slave processors, as “resource conditions”. For example, when another processing unit starts to use many slave processors 13, the image processor 32 changes the combination of processing modules in accordance with a resource use state reported from the resource monitor 61.

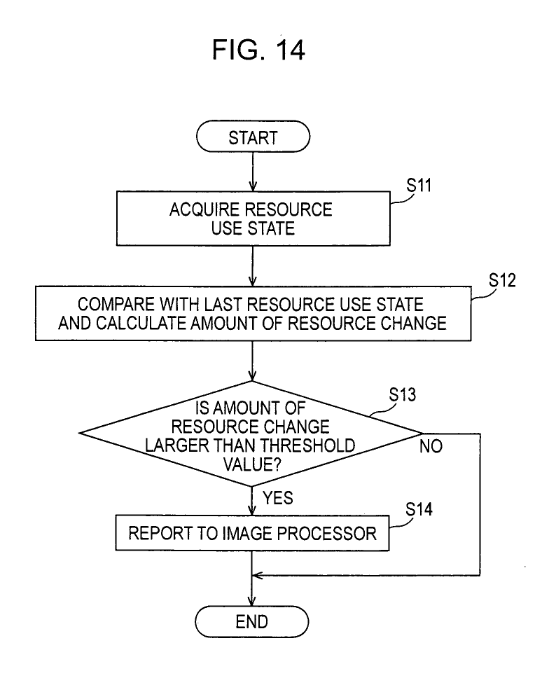

A process performed by the resource monitor 61 is described next with reference to a flowchart shown in FIG. 14.

In step S11, the resource monitor 61 acquires the current resource usage (for example, the number of the slave processors 13 and a bandwidth being used).

In step S12, the resource monitor 61 calculates the amount of resource change by comparing with the resource usage acquired last time. Such calculation of the amount of change is performed for each resource.

In step S13, the resource monitor 61 determines whether or not the amount of resource change is larger than a predetermined threshold value. This determination is performed based on a threshold value for each resource.

If it is determined in step S13 that the amount of change is larger than the threshold value, the resource monitor 61 reports the current resource use state to the module controller 43 of the image processor 32 in step S14. In contrast, if it is determined in step S13 that the amount of change is not larger than the threshold value, the process ends.

The foregoing processing is repeated at a predetermined time.

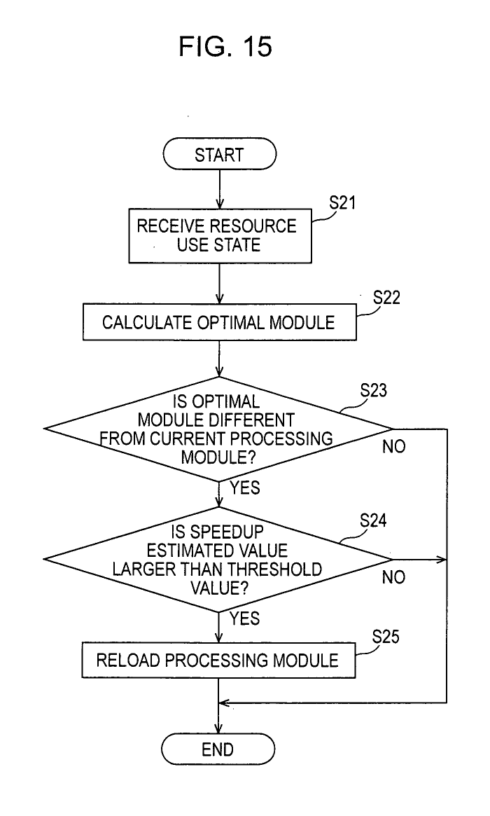

A process performed by the image processor 32 when receiving the report in step S14 is described next with reference to a flowchart shown in FIG. 15.

In step S21, the module controller 43 of the image processor 32 receives the current resource use state from the resource monitor 61, and supplies the current resource use state to the module selector 42.

In step S22, the module selector 42 calculates optimal processing modules and an arrangement of the processing modules in accordance with the resource use state supplied from the module controller 43. In this processing, basically, the profile information 51A is referred to and processing modules are selected, as in the processing of step S2 in FIG. 9.

In step S23, the module selector 42 determines whether or not the processing modules calculated in step S22 are different from the processing modules currently being used. If it is determined that the processing modules calculated in step S22 are different from the processing modules currently being used, it is determined whether or not a speedup estimated value is larger than a predetermined threshold value in step S24.

If it is determined in step S24 that the speedup estimated value is larger than the threshold value, the module selector 42 acquires the processing modules calculated in step S22 from the module manager 41 and supplies the acquired processing modules to the module controller 43 in step S25. The module controller 43 reloads the supplied processing modules to the slave processors 13 via the slave processor manager 33. If a processing module is currently being performed, the slave processor manager 33 sends a termination command, and loads the processing modules after processing for the current frame ends.

Since, depending on the combination of processing modules, a result output from the previous processing module to the main memory 12 may be used as an input, input data must be appropriately set.

As described above, processing modules are reselected and reloaded in accordance with the current resource use state.

If reloading of processing modules is often repeated, due to an overhead, speedup may be canceled out. In order to solve this problem, a threshold value for a speedup estimated value in step S24 may be adaptively changed. More specifically, for example, the threshold value is temporarily increased immediately after an object is reloaded, and the increased threshold value is returned to an original threshold value with the lapse of time. In addition, a difference between the last speedup estimated value and the current speedup estimated value may be stored, and reloading may not be performed until the total sum of the speedup estimated values exceeds an overhead (the threshold value is set to infinite).

Based on statistical information on previous resource use states, an actual speed (a predicted value) of each processing module may be calculated, and a processing module whose predicted value calculated in step S22 is the minimum (the fastest processing module) may be selected.

With such a method, when processing modules 1 and 2 are not optimal for usable resource states A and B since the state A is optimal for the processing module 1 but causes the processing module 2 to be executed at a lower execution speed and since the state B is optimal for the processing module 2 but causes the processing module 1 to be executed at a lower execution speed, if a processing module 3 that can be executed at a predetermined speed or more in the states A and B exists, the processing module 3 that exhibits high performance as an average can be kept selected.

In order to perform such a method, the image processor 32 includes a module selector 71, as shown in FIG. 16, instead of the module selector 42 shown in FIG. 13.

A resource statistical data storage unit 81 of the module selector 71 stores the number of cycles in previous resource use states.

An optimal module calculation unit 82 calculates a predicted value in accordance with previous resource information stored in the resource statistical data storage unit 81 and the profile information 51A stored in the module storage unit 51 of the module manager 41.

More specifically, the optimal module calculation unit 82 samples the stored previous resource information at random, and calculates the number of cycles in the resource use state for each processing module. The optimal module calculation unit 82 calculates a predicted value (or N times of the predicted value) of the number of cycles for each processing module by repeating the processing N times and by calculating the total sum.

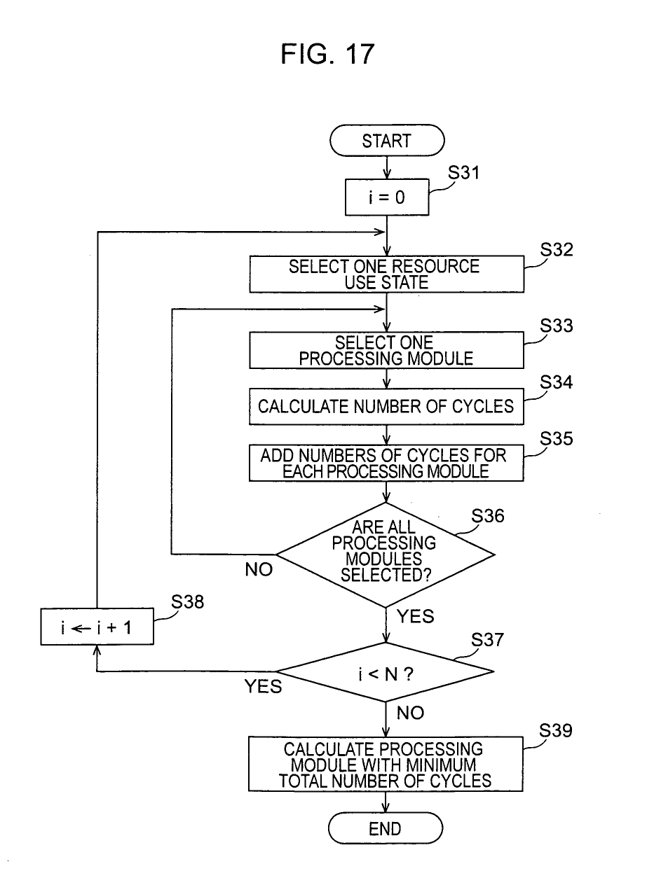

FIG. 17 shows a flowchart of this process. In other words, after a counter i for counting the number of sampling times is initialized to 0 in step S31, one previous resource use state is selected at random from the resource statistical data storage unit 81 in step S32.

In step S33, one existing processing module is selected. In step S34, the number of cycles in the resource use state selected in step S32 for the processing module is calculated.

In step S35, the number of cycles calculated in step S34 is added for each processing module.

In step S36, it is determined whether or not all the processing modules are selected. If it is determined in step S36 that a processing module is not selected, the processing module is selected in step S33. Then, processing subsequent to the processing of step S34 is performed. In other words, the number of cycles for each processing module in the resource use state selected in step S32 is calculated.

If it is determined in step S36 that all the processing modules are selected, it is determined whether or not the counter i is smaller than N in step S37. If it is determined in step S37 that the counter i is smaller than N, the counter i is incremented by 1 in step S38. Then, in step S32, another use state is selected, and processing subsequent to the processing of step S33 is performed. In other words, the total number of cycles in N resource use states for each processing module is calculated.

If it is determined in step S37 that the counter i is equal to N, a processing module whose total number of cycles is the minimum is calculated in step S39.

FIG. 18 shows another example of the functional structure of the image processing apparatus 1. With this structure, the image processing apparatus 1 includes a module manager 91, instead of the module manager 41 of the image processor 32 shown in FIG. 7.

The module manager 91 dynamically generates a compound module for performing a plurality of pieces of filtering processing. The structure of the module manager 91 is described next.

When a request for a compound module for performing a plurality of pieces of filtering processing is received from the module selector 42, a control unit 101 of the module manager 91 supplies to a compound module generation unit 102 a report about the request.

When receiving from the control unit 101 the report about the request for the compound module for performing the plurality of pieces of filtering processing, the compound module generation unit 102 dynamically generates a compound module in response to the request.

For example, if the control unit 101 requests for a compound module for performing “BNR” and “contrast improvement”, the compound module generation unit 102 generates such compound module, and sends the generated compound module to the control unit 101. For example, if the control unit 101 requests for a compound module for performing “BNR” and “contrast improvement” with “a data flow of 10 megabytes or less”, the compound module generation unit 102 generates a compound module that satisfies the “resource condition”, and sends the generated compound module to the control unit 101.

When the compound module generation unit 102 generates a compound module (filter) having a plurality of functions, a simple module source storage unit 103 stores a source of a simple module serving as an original. Specifically, for example, the simple module source is a pre-link object file of a processing module for performing an image processing operation or a source code.

A module storage unit 104 stores processing modules operating on the slave processors 13. The processing modules stored in the module storage unit 104 may be prepared in advance as in the foregoing examples or may be generated by the compound module generation unit 102.

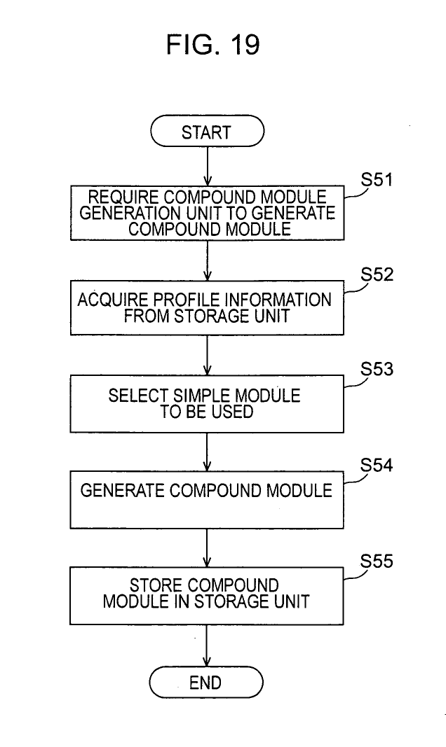

A process performed by the module manager 91 when a request for a compound module is received is described next with reference to a flowchart shown in FIG. 19.

In step S51, the control unit 101 of the module manager 91 requires the compound module generation unit 102 to generate a compound module. “Processing contents” (for example, “BNR” and “contrast improvement”) and “resource conditions” (for example, a data flow of 10 megabytes or less) are reported to the compound module generation unit 102.

In step S52, the compound module generation unit 102 requires acquisition of profile information 103A shown in FIG. 20 about simple modules stored in the simple module source storage unit 103. The simple module source storage unit 103 stores simple modules that can be provided and the profile information 103A on the simple modules. The simple module source storage unit 103 supplies the profile information 103A to the compound module generation unit 102.

In the profile information 103A, “name” represents a label for uniquely identifying a simple module, “processing” represents the name of processing performed by a module, “object size” represents the size of a module itself, and “necessary memory” represents the amount of local memory to which a module is allocated. In addition, “number of cycles” represents the number of cycles of processing, “data(in)” represents the amount of input data, “data(out)” represents the amount of output data, and “data(med)” represents the amount of data necessary for saving a processing intermediate result in the main memory 12.

In step S53, the compound module generation unit 102 determines simple modules to be used in accordance with the acquired profile information 103A. Here, a combination that best satisfies the “resource conditions” received from the control unit 101 is selected. This processing will be described.

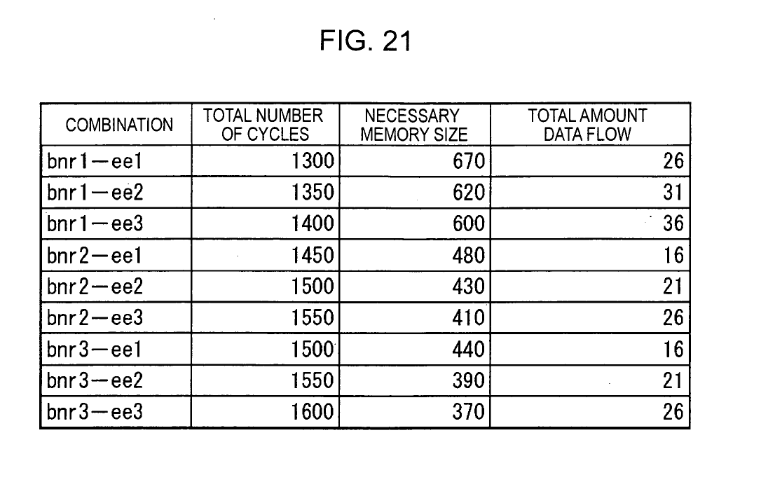

For example, if received “processing contents” are “BNR” and “edge enhancement filtering”, simple modules bnr_1, bnr_2, and bnr_3 exist as simple modules for “BNR”, and simple modules ee_1, ee_2, and ee_3 exist as simple modules for “edge enhancement filtering”, as shown in FIG. 20. Thus, nine combinations exist. A profile is prepared for each combination, as shown in FIG. 21.

For example, if received “resource conditions” are “one slave processor” and “a usable local memory of 600 bytes or less”, a combination of the simple module bnr_1 and the simple module ee_3 with the “necessary memory amount” of 600 bytes or less and with the minimum “number of cycles” is selected.

If the “resource conditions” are “one slave processor”, “a usable local memory of 1000 bytes or less”, and “a data flow of 30 megabytes or less”, a combination of the simple module bnr_1 and the simple module ee_1 is selected.

Referring back to FIG. 19, in step S54, the compound module generation unit 102 acquires from the simple module source storage unit 103 the simple modules selected in step S53, and generates a compound module by combining the acquired simple modules. The compound module generation unit 102 supplies the generated compound module to the control unit 101. The generated compound module is an execution object that can be operated by the slave processor 13.

In step S55, the control unit 101 stores the compound module supplied from the compound module generation unit 102 and profile information of the compound module in the module storage unit 104. At this time, a fact that the stored compound module is a dynamically generated module (a module generated by the compound module generation unit 102) is recorded in the module storage unit 104. This is because the compound module can be deleted when many compound modules are generated and the module storage unit 104 does not have a sufficient memory size. Since dynamically generated compound modules can be regenerated when necessary, such compound modules can be deleted.

As described above, a compound module having a plurality of functions is generated.

Here, the simple module source storage unit 103 may store a plurality of compiled objects for one algorithm. Alternatively, one source code may be stored for one algorithm so that different objects can be generated by changing a compile option when a request is given. In this case, however, the number of cycles of the profile information 103A of a simple module is an estimated value.

In addition, a simple module is not necessarily a module for performing an image processing operation, and a simple module may perform a plurality of processing operations. In other words, the term “simple module” means a module capable of forming a compound module by combining a plurality of simple modules together.

In addition, although a case where processing procedures are “BNR”, “edge enhancement filtering”, and “format conversion” has been described, in a case where interchangeable filters (a pair of filters that exhibit a same result even if the order changes) are used or a case where a request from the system controller 31 does not include the processing order since changing the processing order does not cause a large difference, filters can be combined in any order.

In addition, when the direction of processing image data by a simple module (filter module) is fixed, if filters having different processing directions are combined together, an intermediate result must be stored in the main memory 12, thus increasing an overhead. For example, when a “BNR” filter needs to perform processing on an image in a horizontal direction and a “contrast improvement” filter needs to perform processing on an image in the vertical direction, the two filters should not be combined together.

As shown in the column for “dependency data” in FIG. 20, by storing information on a processing direction of a filter module, when the module is selected, the compound module generation unit 102 of the module manager 91 can determine a combination by taking into consideration such information. “Horizontal direction” in the column for the “dependency data” represents that processing should be performed in the horizontal direction of an image. “Vertical direction” in the column for the “dependency data” represents that processing should be performed in the vertical direction of an image. The mark “*” in the column for the “dependency data” represents that processing can be performed in a desired direction of an image.

An example of a case where modules for “edge enhancement” and “RGB conversion” are combined together will be described with reference to FIG. 20. In this case, since simple modules ee_2 and ee_3 are capable of performing processing in a desired direction, the simple modules ee_2 and ee_3 can be connected to each of simple modules rgb_1, rgb_2, and rgb_3. However, if a simple module ee_1 is used, the simple module rgb_2 or the simple module rgb 3 must be selected since the simple module rgb_1 cannot be used. Thus, apart from resource limit, the combination of the simple module ee_2 and the simple module rgb_1 whose total number of cycles is 850 is optimal.

FIG. 22 shows another example of the functional structure of the image processing apparatus 1. With this structure, the image processor 32 shown in FIG. 7 further includes a module profile update unit 111.

If a compound module is dynamically generated, in particular, if a compound module is dynamically updated from a source code, the performance of the compound module is unknown. Thus, the module profile update unit 111 feeds back to the module manager 41 a result obtained by an operation of the generated compound module.

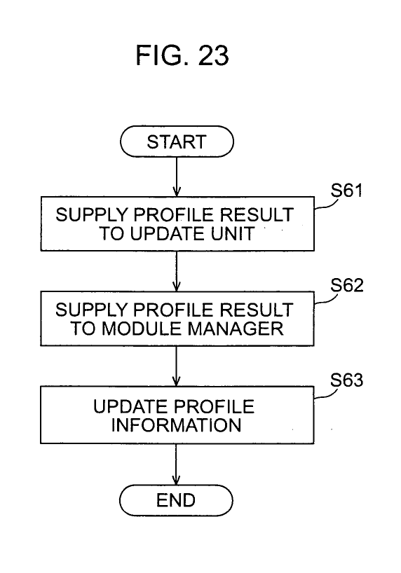

A profile update process is described with reference to a flowchart shown in FIG. 23.

In step S61, the module controller 43 of the image processor 32 sends to the module profile update unit 111 a notice of termination of module execution when processing of a processing module ends. At this time, profile results, such as time required for the processing and the amount of a data flow, are also sent to the module profile update unit 111. The module profile update unit 111 can cause the module controller 43 to set how often termination of a module is noticed.

In step S62, the module profile update unit 111 sends profile information of the execution results to the module manager 41. In step S63, the module manager 41 updates the profile information 51A of the processing module in accordance with the information. More specifically, if a module profile does not exist, a given value is set. If a value exists, for example, an average of the existing value and a new value is set.

As described above, the profile information 51A is updated.

Although image processing has been described as an example, the present invention is also applicable to general data processing and signal processing, such as sound processing.

In this specification, steps for a program supplied from a recording medium are not necessarily performed in chronological order in accordance with the written order. The steps may be performed in parallel or independently Without being performed in chronological order.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus including a plurality of slave processors connected to a system bus and a main processor controlling the plurality of slave processors, the information processing apparatus comprising:
holding means for holding profile information of processing modules executable by the slave processors;
selection means for selecting processing modules to be executed by the slave processors in accordance with the profile information;
execution means for causing the slave processors to execute the processing modules selected by the selection means;
generation means for generating a compound module for performing a plurality of pieces of processing by combining predetermined simple modules in response to a request; and
storage means for storing the compound module generated by the generation means,
wherein the profile information includes dependency information of input data, and
wherein the generation means generates the compound module in accordance with the dependency information.

2. The information processing apparatus according to claim 1, wherein the profile information includes a processing speed, the amount of memory used, or a system bus usage for each of the processing modules.

3. The information processing apparatus according to claim 1, further comprising:
acquisition means for acquiring profile results corresponding to execution of the processing modules; and
update means for updating the profile information in accordance with the profile results.

4. The information processing apparatus according to claim 1, further comprising monitoring means for monitoring a use state of a resource during execution of the processing modules, wherein
the selection means reselects processing modules to be executed by the slave processors in accordance with the use state of the resource.

5. The information processing apparatus according to claim 4, wherein the resource includes a bandwidth of the system bus, the number of slave processors executing the processing modules, or a usage rate of the slave processors.

6. The information processing apparatus according to claim 4, further comprising previous data holding means for holding previous resource information, wherein
the selection means reselects the processing modules to be executed by the slave processors in accordance with the previous resource information.

7. An information processing method for an information processing apparatus including a plurality of slave processors connected to a system bus and a main processor controlling the plurality of slave processors, the method comprising the steps of:
holding profile information of processing modules executable by the slave processors;
selecting processing modules to be executed by the slave processors in accordance with the profile information;
causing the slave processors to execute the processing modules selected by the selecting step;
generating a compound module for performing a plurality of pieces of processing by combining predetermined simple modules in response to a request; and
storing the compound module generated by the generating step,
wherein the profile information includes dependency information of input data, and
wherein the compound module is generated by the generating step in accordance with the dependency information.

8. A program for causing a main processor controlling a plurality of slave processors connected to a system bus in an information processing apparatus to perform processing comprising the steps of:
holding profile information of processing modules executable by the slave processors;
selecting processing modules to be executed by the slave processors in accordance with the profile information;
causing the slave processors to execute the processing modules selected by the selecting step;
generating a compound module for performing a plurality of pieces of processing by combining predetermined simple modules in response to a request; and
storing the compound module generated by the generating step,
wherein the profile information includes dependency information of input data, and
wherein the compound module is generated by the generating step in accordance with the dependency information.

9. An information processing apparatus including a plurality of slave processors connected to a system bus and a main processor controlling the plurality of slave processors, the information processing apparatus comprising:
a holding unit holding profile information of processing modules executable by the slave processors;
a selection unit selecting processing modules to be executed by the slave processors in accordance with the profile information;
an execution unit causing the slave processors to execute the processing modules selected by the selection unit;
a generation unit generating a compound module for performing a plurality of pieces of processing by combining predetermined simple modules in response to a request; and
a storage unit storing the compound module generated by the generation unit,
wherein the profile information includes dependency information of input data, and
wherein the generation unit generates the compound module in accordance with the dependency information.
